(19) United States
(12) Patent Application Publication
(10) Pub. No.: US 2008/0009302 A1
(43) Pub. Date: Jan. 10, 2008

(54) APPARATUS AND METHOD FOR CHANNEL FEEDBACK IN A WIRELESS COMMUNICATION SYSTEM

(75) Inventors: Myeon-Kyun CHO, Seongnam-si (KR); Yung-Soo Kim, Seongnam-si (KR); Cheol-Woo You, Seoul (KR); Woo-Hyun Seo, Seoul (KR); Daesik Hong, Seoul (KR)

Correspondence Address: Jefferson IP Law, LLP, 1730 M STREET, NW, SUITE 807, WASHINGTON, DC, 20036, US

(73) Assignees: Samsung Electronics Co., LTD., Suwon-si (KR); Industry-Academic Cooperation Foundation, Yonsei University, Seoul (KR)

(21) Appl. No.: 11/770,055

(22) Filed: Jun. 28, 2007

(30) Foreign Application Priority Data
Jul. 6, 2006 (KR) 2006-0063303

(51) Int. Cl. H04Q 7/20

(52) U.S. Cl. 455/517

(57) ABSTRACT

An apparatus and method for feeding back Channel Quality Information (CQI) in a wireless communication system are provided. Total channels are grouped into certain number of groups according to downlink channel estimates. Group indexes are determined for the channels. Feedback information is generated using the group indexes of the channels and representative values of the groups. Then, the generated feedback information can be transmitted.

### PRIORITY

This application claims the benefit under 35 U.S.C. §119 (a) to a Korean patent application filed on Jul. 6, 2006 in the Korean Intellectual Property Office and assigned Serial No. 2006-63303, the entire disclosure of which is hereby incorporated by reference.

### BACKGROUND OF THE INVENTION

1. Field of the Invention

The present invention relates generally to an apparatus and method for feeding back Channel Quality Information (CQI) in a wireless communication system. More particularly, the present invention relates to an apparatus and method for feeding back the CQI of a total frequency band with a small amount of feedback information, in a wireless communication system.

2. Description of the Related Art

A wireless communication system conducts communications using radio resources. However, the radio resource environment may suffer from changes affecting a channel. Therefore, CQIs of radio resources for users are required to transmit signals fast and accurately to the users. The users monitor their downlink channel statuses and feed back the CQIs to a serving Base Station (BS).

FIGS. 1A and 1B illustrate a conventional best-M feedback scheme.

Referring to FIGS. 1A and 1B, the best-M feedback scheme selects the CQIs of M channels having the best status from among all of the frequency channels and feeds back the CQIs.

For example, if M is 5, a user selects channels 1, 4, 5, 13 and 14 which have the best status from a total frequency band, as illustrated in FIG. 1A.

The user then feeds back 25-bit data which indicates the locations of the selected channels and a 25-bit CQI value of the channels, as illustrated in FIG. 1B.

FIGS. 2A and 2B illustrate a conventional Contiguous CQI Feedback Scheme (CCFS).

Referring to FIGS. 2A and 2B, a wireless communication system using the CCFS divides a total frequency band according to CQI levels. Each user transmits one CQI with respect to each CQI level.

As the user feeds back a one-level CQI at one time, previous feedback information is updated with the next feedback channel information. For example, the user feeds back a CQI value of 1, a CQI value of 4, a CQI value of 10 and then a CQI value of 13 for level 1, 2, 3, and 4 sequentially, as illustrated in FIG. 2A.

The above-described conventional feedback schemes are not suitable for channel allocation aiming at both throughput and fairness because only the CQIs of channels in average or better statuses are fed back. To ensure throughput and fairness, the wireless communication system adopts a Proportional Fairness (PF) scheduling or an Adaptive Channel Allocation (ACA), for example. The PF scheduling or the ACA is characterized in that a limit is imposed on a user to which a channel has been allocated and a weight is applied to a user to which a channel has not been allocated in order to maximize throughput and guarantee fairness.

If the BS has no knowledge of bad channels in the feedback schemes, it may allocate the bad channels to users. More specifically, to reduce the uplink load of feedback information, only the CQIs of part of frequency bands are fed back. Thus, the BS may allocate channels whose CQIs are not known to the BS to the users. As a result, the users may have decreased reception quality.

However, if each user feeds back the CQIs of all channels, the amount of resources used for the feedback is increased and the feedback adds to overhead with respect to limited radio resources.

### SUMMARY OF THE INVENTION

An aspect of the present invention is to address at least the above problems and/or disadvantages and to provide at least the advantages described below. Accordingly, an aspect of the present invention is to provide an apparatus and method for feeding back a CQI in a wireless communication system.

Another aspect of the present invention is to provide an apparatus and method for feeding back the CQI of a total frequency band in a wireless communication system.

A further aspect of the present invention is to provide an apparatus and method for feeding back the CQI of a total frequency band with a small amount of feedback information in a wireless communication system.

Still another aspect of the present invention is to provide an apparatus and method for feeding back the CQI of a total frequency band through channel grouping in a wireless communication system.

In accordance with an aspect of the present invention, an apparatus for feeding back CQI in a wireless communication system is provided. The apparatus includes a channel estimator for estimating downlink channels using a received signal and for outputting channel estimates, and a CQI generator for grouping total channels into groups according to the channel estimates and for generating feedback information using group indexes of the channels and representative values of the groups.

In accordance with another aspect of the present invention, a method for feeding back CQI in a wireless communication system is provided. The method includes grouping total channels into groups according to downlink channel estimates, determining group indexes for the channels, and generating feedback information using the group indexes of the channels and representative values of the groups.

### BRIEF DESCRIPTION OF THE DRAWINGS

The above and other objects, features and advantages of certain exemplary embodiments of the present invention will become more apparent from the following detailed description when taken in conjunction with the accompanying drawings in which:

FIGS. 1A and 1B illustrate a conventional best-M feedback scheme;

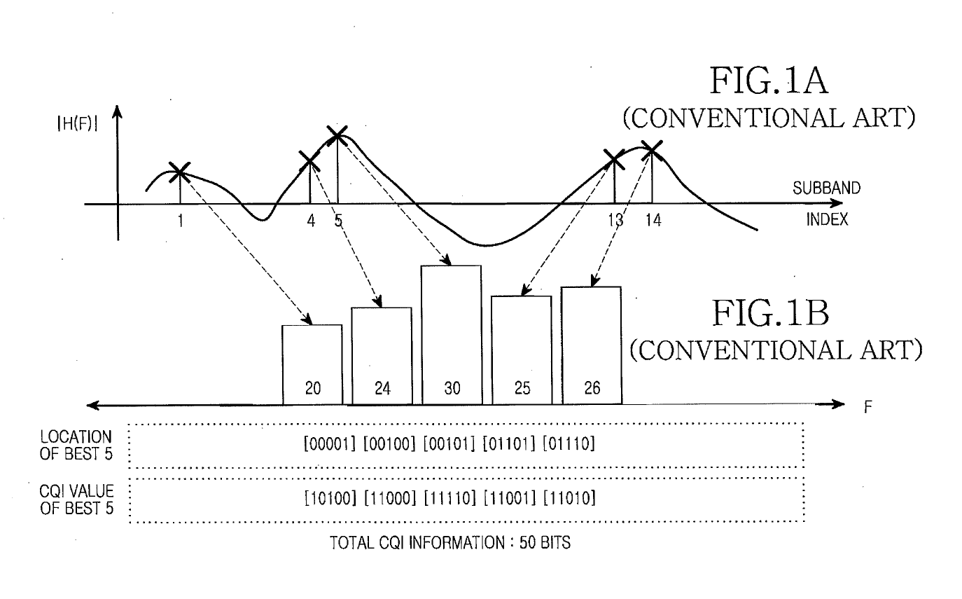

FIGS. 2A and 2B illustrate a conventional CCFS;

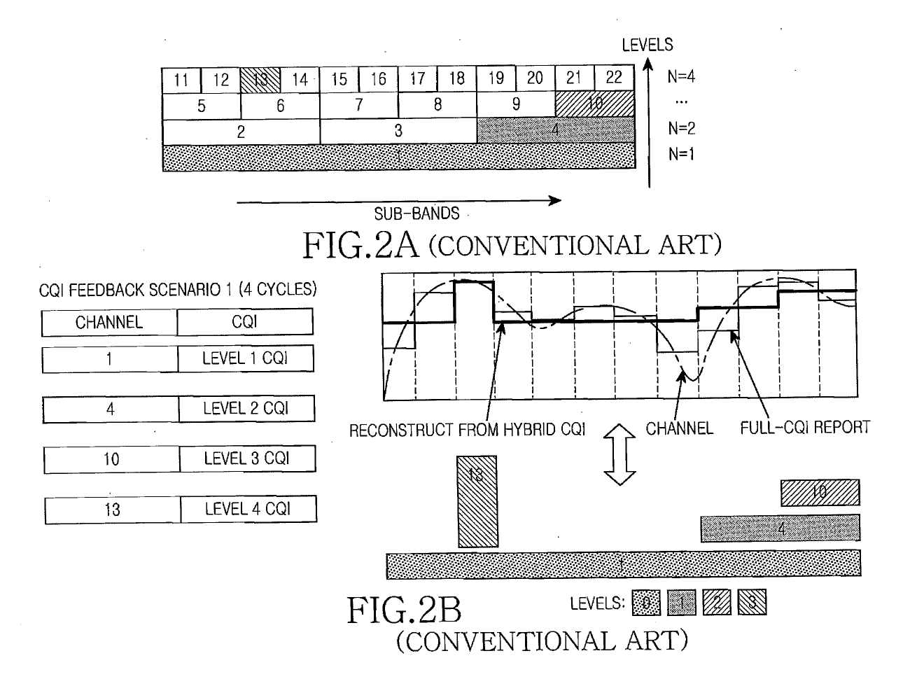

FIG. 3 is a block diagram of a Mobile Station (MS) for feeding back a CQI according to an exemplary embodiment of the present invention;

FIG. 4 is a detailed block diagram of a CQI generator according to an exemplary embodiment of the present invention;

FIG. 5 is a flowchart illustrating a CQI grouping operation according to an exemplary embodiment of the present invention;

FIG. 6 is a flowchart illustrating a CQI feedback operation according to an exemplary embodiment of the present invention;

FIG. 7 illustrates a CQI grouping scheme according to an exemplary embodiment of the present invention;

FIG. 8 illustrates an Adaptive Grouping Feedback Scheme (AGFS) according to an exemplary embodiment of the present invention;

FIG. 9 illustrates a time-division grouping feedback scheme according to an exemplary embodiment of the present invention;

FIGS. 10A and 10B are graphs illustrating performance variations according to an exemplary embodiment of the present invention; and

FIG. 11 is a graph illustrating performance variations according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of the exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

An exemplary embodiment of the present invention provides an apparatus and method for adaptively grouping channels according to their statuses and for feeding back the CQI of a total frequency band based on the channel grouping. While an exemplary embodiment of the present invention is described in the context of an Orthogonal Frequency Division Multiple Access (OFDMA) communication system, it is also applicable to communication systems using other multiple access schemes.

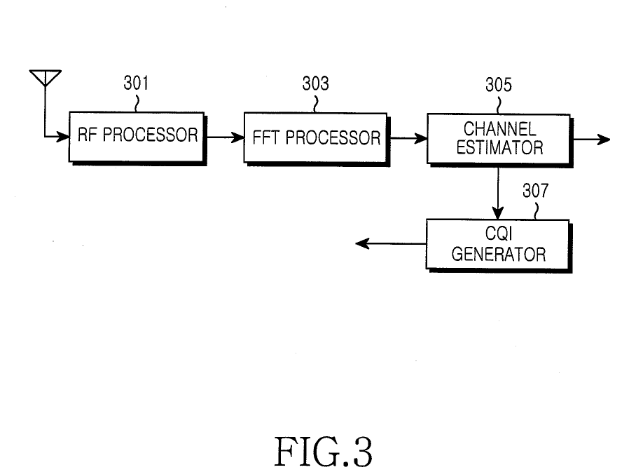

FIG. 3 is a block diagram of an MS for feeding back a CQI according to an exemplary embodiment of the present invention.

Referring to FIG. 3, the MS includes a Radio Frequency (RF) processor 301, a Fast Fourier Transform (FFT) processor 303, a channel estimator 305, and a CQI generator 307.

The RF processor 301 downconverts an RF signal received through an antenna to a baseband signal.

The FFT processor 303 converts the time signal received from the RF processor 301 to a frequency signal by FFT.

The channel estimator 305 estimates downlink channels by using a pilot signal included in the frequency signal.

The CQI generator 307 groups channels in similar statuses among the total frequency channels by using downlink channel estimates received from the channel estimator 305. The CQI generator 307 determines a representative value for each channel group and generates feedback information with the group indexes of the channels and the representative values of the groups.

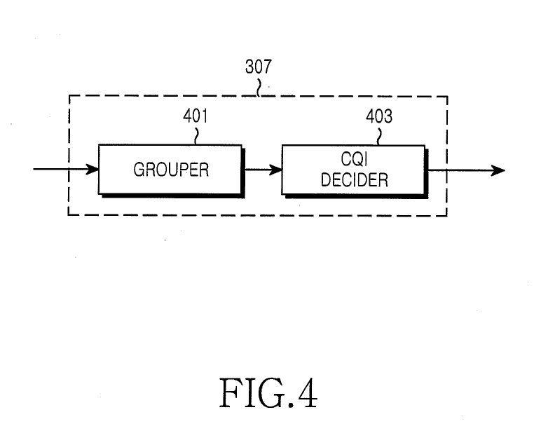

The CQI generator 307 can be configured as illustrated in FIG. 4.

FIG. 4 is a detailed block diagram of the CQI generator according to an exemplary embodiment of the present invention.

Referring to FIG. 4, the CQI generator 307 includes a grouper 401 and a CQI decider 403.

The grouper 401 orders the total frequency channels according to the channel estimates received from the channel estimator 305 and groups them so as to minimize Mean Squared Error (MSE). For example, the grouper 401 divides the total frequency channels into groups each having the same number of channels. Then the grouper 401 selects two groups, starting from a group in the poorest channel status and adjusts a separation point between every pair of two adjacent groups. The representative value of each group is assumed to be the average of the channel estimates of channels included in the group. The grouper 401 calculates the MSE by

$${σ}_{i} = {\sum }_{j = {N}_{0} + … + {N}_{i - 1} + 1}^{{N}_{0} + … + {N}_{I}} {( {x}_{j} - {m}_{i} )}^{2} , 1 \leq i \leq L \qquad ( 1 )$$

where Nᵢ denotes the number of channels in an i^{th} group, xⱼ denotes the CQI of a j^{th} channel, mᵢ denotes the representative value (i.e. average) of the i^{th} group, and L denotes the number of the total groups.

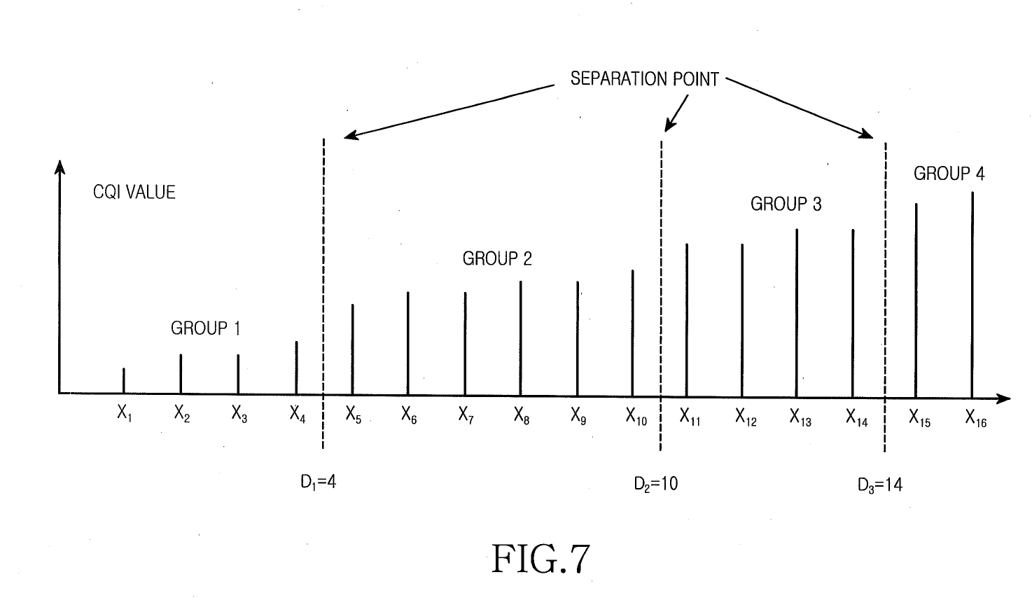

The grouper 401 groups the total frequency channels by Equation (1) as illustrated in FIG. 7.

FIG. 7 illustrates a CQI grouping scheme according to an exemplary embodiment of the present invention.

Referring to FIG. 7, given 16 channels in total, the grouper 401 orders the 16 channels and groups them into four groups.

The grouper 401 determines a separation point between group 1 and group 2 in the poorest channel status so as to minimize the MSEs of the two groups. That is, the grouper 401 calculates an MSE variation that can occur when a channel in one group moves to the other group, for each channel in group 1 and group 2 and then determines a separation point that minimizes the MSEs of the two groups. When a channel x_{N}_{₁}₊₁ in group 2 is moved to group 1, the resulting MSE variation is computed by

$$f ( {x}_{{N}_{I} + 1} ) = \frac{{N}_{1}}{{N}_{1} + 1} {( {x}_{{N}_{I} + 1} - {m}_{1} )}^{2} - \frac{{N}_{2}}{{N}_{2} - 1} {( {x}_{{N}_{I} + 1} - {m}_{2} )}^{2} \qquad ( 2 )$$

where Nᵢ denotes the number of the channels in the i^{th} group, mᵢ denotes the representative value of the i^{th} group, and xₙ_{₁} denotes the CQI of the channel that is moved from group 2 to group 1.

When a channel x_{N}_{₁} in group 1 is moved to group 2, the resulting MSE variation is computed by

$$f ( {x}_{{N}_{I}} ) = \frac{{N}_{2}}{{N}_{2} + 1} {( {x}_{{N}_{I} + 1} - {m}_{2} )}^{2} - \frac{{N}_{1}}{{N}_{I} - 1} {( {x}_{{N}_{I}} - {m}_{1} )}^{2} \qquad ( 3 )$$

where Nᵢ denotes the number of the channels in the i^{th} group, mᵢ denotes the representative value of the i^{th} group, and xₙ_{₁} denotes the CQI of the channel that is moved from group 1 to group 2.

The grouper 401 compares the MSE variations calculated by Equation (2) and Equation (3). If a smaller MSE variation is less than 0, the separation point between the two groups is in a position corresponding to the smaller MSE variation. The grouper 401 continues to change the separation point until the MSE variations computed by Equation (2) and Equation (3) become larger than 0.

After determining a separation point that minimizes the MSEs of group 1 and group 2, the grouper 401 selects the next better-status groups, i.e. group 2 and group 3 and repeats the above operation to determine a separation point between group 2 and group 3. The grouper 401 may group the channels according to their statuses for every CQI feedback period.

If four channel groups are produced, the grouper 401 determines a separation point between group 1 and group 2, a separation point between group 2 and group 3, and a separation point between group 3 and group 4 so that the MSEs of the groups are minimized, as illustrated in FIG. 7.

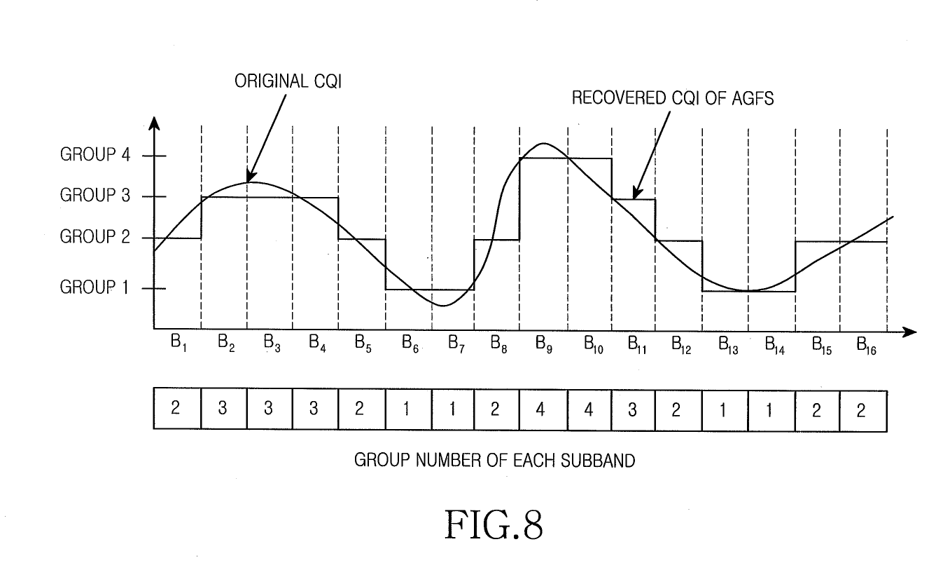

The CQI decider 403 determines a group index for each channel according to the grouping of the grouper 401. For instance, the CQI decider 403 determines group indexes for the respective channels as illustrated in FIG. 8 based on the grouping illustrated in FIG. 7.

FIG. 8 illustrates an AGFS according to an exemplary embodiment of the present invention.

Referring to FIG. 8, the CQI decider 403 determines a group index for each of the 16 channels based on the grouping that minimizes MSE as illustrated in FIG. 7. For example, the CQI decider 403 may determine a group index for each channel by the CQI of the channel with the representative value of each group.

Subsequently, the CQI decider 403 generates feedback information including the group index of each channel and the representative value of each group and transmits the feedback information to the BS.

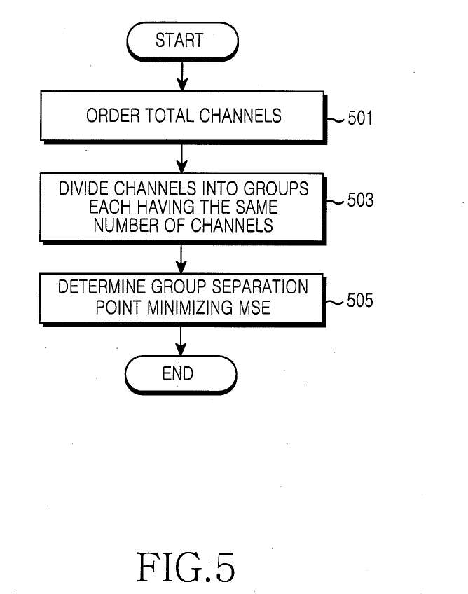

FIG. 5 is a flowchart illustrating a CQI grouping operation, i.e. grouping in the grouper 401 illustrated in FIG. 4 according to an exemplary embodiment of the present invention.

Referring to FIG. 5, the grouper 401 sequentially orders total channels according to the channel estimates of the channels in step 501 and groups the channels so that each group has the same number of channels in step 503. For example, 16 entire channels are divided into four groups each having four channels.

In step 505, the grouper 401 selects two groups, starting from a group in the poorest channel status and determines a separation point between every pair of adjacent groups so that the MSEs of the two groups are minimized. For example, the grouper 401 calculates MSE variations that may occur when a channel moves from one group to the other group according to Equation (2) and Equation (3) and determines a separation point that minimizes the MSEs of the two groups.

Then, the grouper 401 ends the algorithm of an exemplary embodiment of the present invention.

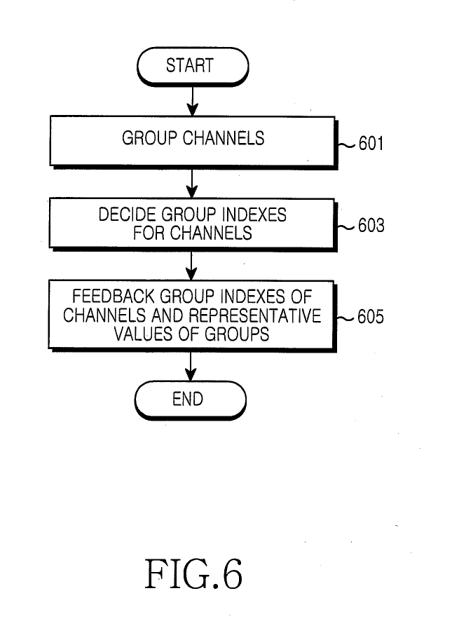

The MS generates feedback information based on group information created in the procedure of FIG. 5 and transmits the feedback information in the manner illustrated in FIG. 6.

FIG. 6 is a flowchart illustrating a CQI feedback operation according to an exemplary embodiment of the present invention.

Referring to FIG. 6, the MS groups total frequency channels so as to minimize MSE according to the procedure of FIG. 5 in step 601. The MS determines group indexes for the channels by comparing the CQIs of the channels with the representative values of the groups in step 603. Herein, the representative value of a group is assumed to the average of the group.

In step 605, the MS feeds back the group indexes of the channels and the representative values of the groups to the BS. Then the MS ends the algorithm.

In accordance with an exemplary embodiment of the present invention, the MS groups total frequency channels and then feeds back the group indexes of the channels and the representative values of the groups.

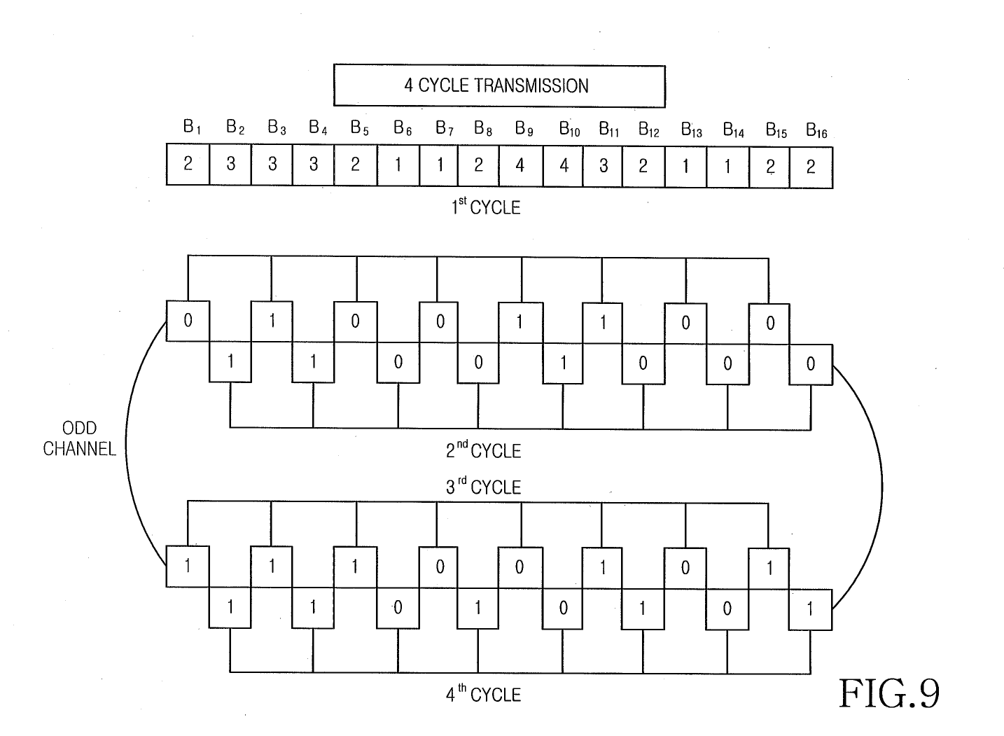

In another exemplary implementation of the present invention, the group index of each channel is transmitted in time division as illustrated in FIG. 9 in order to further reduce the amount of the feedback information.

FIG. 9 illustrates a time-division grouping feedback scheme according to an exemplary embodiment of the present invention. In order to reduce errors in feedback information, the indexes of groups are Grey-mapped.

Referring to FIG. 9, when channels are grouped into four groups, the indexes of the groups can be expressed in two bits. Therefore, the MS can transmit information about the group index of each channel by time-dividing two bits into two single bits.

Now a description will be made of performance variations in the case of feedback by an AGFS in the wireless communication system. To evaluate AGFS performance variations, a simulation was performed under the conditions of a bandwidth of 10 MHz, 16 subbands, 8 users, and a carrier of 2 GHz.

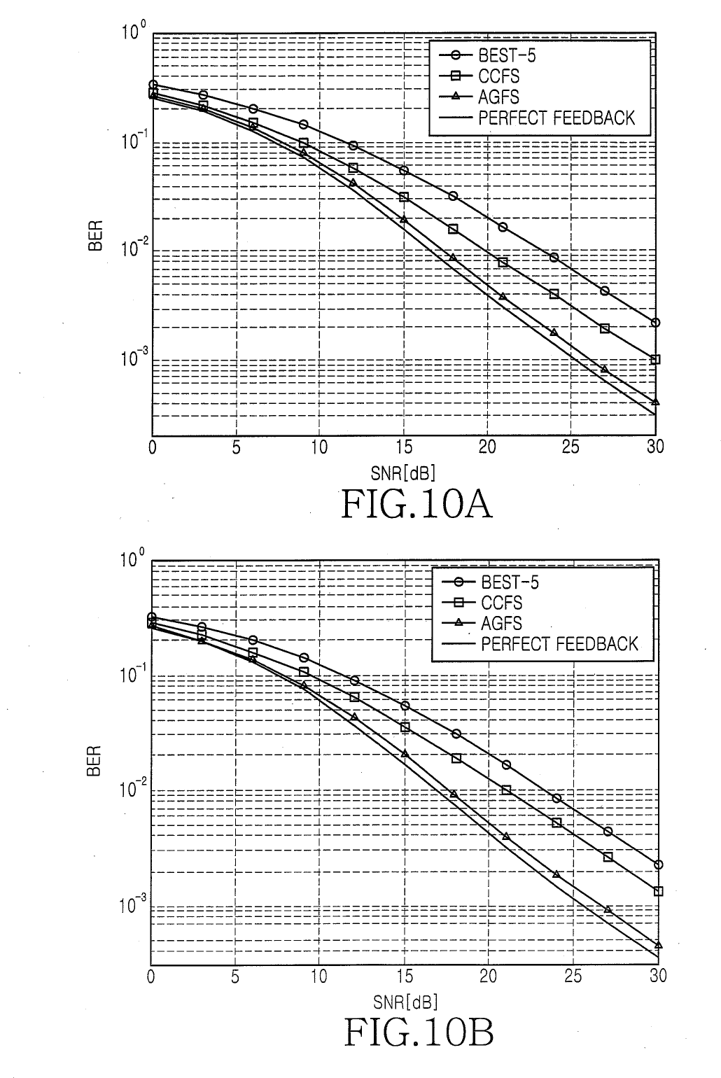

FIGS. 10A and 10B are graphs illustrating performance variations according to an exemplary embodiment of the present invention. The vertical axis represents Bit Error Rate (BER) and the horizontal axis denotes Signal-to-Noise Ratio (SNR). That is, BER is illustrated with respect to positions of the MS.

Specifically, FIG. 10A illustrates the performance variations of different feedback schemes when ACA is performed using a feedback CQI and FIG. 10B illustrates the performance variations of the feedback schemes when PF is performed using a feedback CQI.

Referring to FIGS. 10A and 10B, the AGFS of an exemplary embodiment of the present invention perform almost the same as perfect feedback of non-quantized information about entire channels and outperforms the CCFS by 4 dB or above in BER.

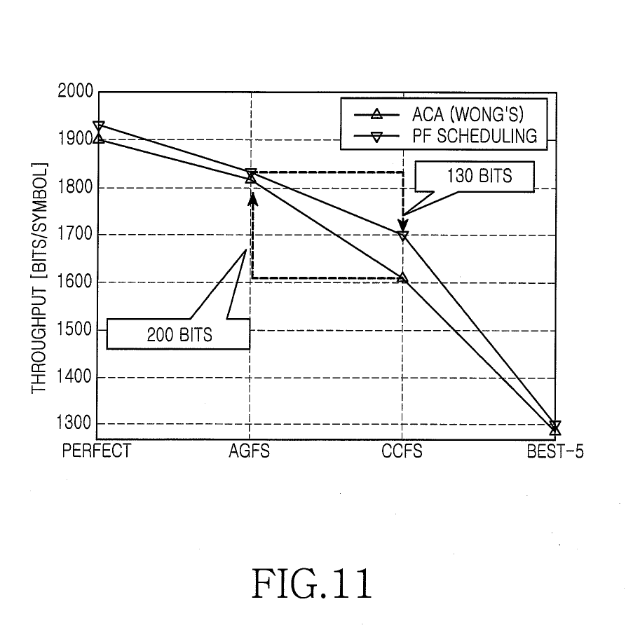

FIG. 11 is a graph illustrating performance variations according to an

Referring to FIG. 11, the graph illustrates the throughputs of the feedback schemes when an Adaptive Modulation and Coding Scheme (AMCS) is used after channel allocation based on a feedback CQI.

As noted from the graph, the AGFS performs almost the same as the perfect feedback scheme and outperforms the CCFS by about 100 bits/symbol or above in throughput. Thus it can be concluded that the AGFS offers higher throughput than the CCFS because the AGFS provides an accurate CQI of entire channels.

As described above, the AGFS of an exemplary embodiment of the present invention performs well, compared to the CCFS or the best-M scheme. For example, the AGFS uses a similar amount of feedback information to that of the CCFS or the best-M scheme, as illustrated in Table 1 below.

TABLE 1

| | |
|---|---|
| Feedback | Amount of feedback information per slot |

| scheme | General case | Simulation |
|---|---|---|
| AGFS | [N · ┌log₂ L┐ + 5 · L]/C | 13 bits |
| CCFS | [C · (5 + 5)]/C | 10 bits |
| Best-M | [M · {┌log₂ N┐ + 5 + (C − 1)}]/C | 15 bits |

Table 1 illustrates the amounts of feedback information per unit time when information about L groups is fed back in C unit times in the AGFS, CCFS, and best-M scheme, respectively. For example, for 16 subbands or channels (N=16), five groups (L=5), and four unit times (C=4), assuming that every CQI is 5 bits in length, the AGFS, the CCFS, and the best-M scheme require similar feedback amounts, i.e., 13 bits, 10 bits, and 15 bits respectively.

In accordance with exemplary embodiments of the present invention as described above, total channels are adaptively grouped according to their statuses so as to narrow the difference between an original CQI and a recovered CQI and then the group index of each channel and the representative value of each group are fed back in a wireless communication system. The accurate feedback of the CQI of a total frequency band from a receiver to a transmitter increases higher throughput and minimizes necessary information. Therefore, the frequency efficiency of the system is maximized.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A mobile apparatus for feeding back Channel Quality Information (CQI) in a wireless communication system, comprising:
a RF processor for down-converting an RF signal received through an antenna to a baseband signal;
a FFT processor for converting the down-converted signal received from the RF processor to a frequency signal by a fast Fourier Transform;
a channel estimator for estimating downlink channels using the frequency signal.
a CQI generator for grouping channels in similar statuses among the total frequency channels by using the estimated downlink channel and determines a representative value for each channel group;
a transmitter for feeding back CQI with the representative value for each channel group and indexes of group of the channels

2. The apparatus of claim 1, wherein the channel estimator estimates downlink channels using a pilot signal included in the frequency signal.

3. The apparatus of claim 1, wherein the CQI generator comprises:
a grouper for grouping the total channels into the groups according to the channel estimates; and
a CQI decider for determining the group indexes for the channels and for generating the feedback information using the indexes of group of the channels and the representative values of the groups.

4. The apparatus of claim 3, wherein the grouper orders the total channels according to the channel estimates, sequentially groups the ordered channels into groups each having the same number of channels, and determines group separation points so as to minimize Mean Squared Errors (MSEs) of the groups.

5. The apparatus of claim 1, wherein the CQI generator for grouping channels in similar statuses among the total frequency channels, starting from a group in the poorest channel status

6. The apparatus of claim 4, wherein the grouper determines a group separation point between two selected groups so that the MSEs of the two groups are minimized.

7. The apparatus of claim 1, wherein the representative values of the groups are the averages of channels included in the groups.

8. The apparatus of claim 1, wherein the CQI generator groups the total channels for every feedback period.

9. The apparatus of claim 1, wherein the CQI generator generates feedback information about total frequency channels using the group indexes of the channels and the representative values of the groups.

10. The apparatus of claim 1, wherein the CQI generator generates the feedback information by time-dividing the group indexes of the channels and the representative values of the groups.

11. The apparatus of claim 10, wherein the group indexes are Grey-mapped.

12. The apparatus of claim 1, wherein the transmitter transmits the CQI information to a base station over the CQI channel in wireless communication system.

13. A method for feeding back Channel Quality Information (CQI) in a wireless mobile communication system, comprising:
down-converting, at a RF processor, an RF signal received through an antenna to a baseband signal;
converting the down-converted signal received from the RF processor to a frequency signal by a fast Fourier Transform;
estimating downlink channels using the converted frequency signal.
grouping total channels into groups in similar status according to downlink channel estimates;
determining indexes of group for the channels; and
generating feedback information using the indexes of group of the channels and representative values of each channel groups.

14. The method of claim 13, wherein the grouping of the total channels comprises:
ordering the total channels according to the downlink channel estimates and sequentially grouping the ordered channels into groups each having the same number of channels; and
determining group separation points so as to minimize Mean Squared Errors (MSEs) of the groups.

15. The method of claim 14, wherein the determining of the group separation points comprises:
selecting two groups among the total groups;
calculating an MSE variation when a channel moves from one group to another group; and
determining a group separation point that decreases the MSEs of the two groups.

16. The method of claim 14, wherein the determining of the group separation points comprising:
sequentially selecting the groups by two;
starting from a group in the poorest channel status; and
determining a group separation point between two groups.

17. The method of claim 13, wherein the representative values of the groups are the averages of channels included in the groups.

18. The method of claim 13, wherein the grouping of the total channels comprises grouping the total channels for every feedback period.

19. The method of claim 13, wherein the generating of the feedback information comprises generating feedback information about total frequency channels using the group indexes of the channels and the representative values of the groups.

20. The method of claim 13, wherein the generating of the feedback information comprises generating the feedback information by time-dividing the group indexes of the channels and the representative values of the groups.

21. The method of claim 20, wherein the group indexes are Grey-mapped.

22. The method of claim 13, further comprising transmitting the feedback information to a base station through a CQI channel.

23. An apparatus for feeding back Channel Quality Information (CQI) in a wireless communication system, comprising:
a channel estimator for estimating downlink channels using a received signal and for outputting channel estimates; and
a CQI generator for grouping total channels into groups according to the channel estimates and for generating feedback information using indexes of group of the channels and representative values of the groups.

24. The apparatus of claim 23, wherein the generated feedback information is transmitted over a CQI channel.

25. The apparatus of claim 23, wherein the CQI generator for grouping total channels into each channel groups in poorest channel order according the channel estimates

26. A method for feeding back Channel Quality Information (CQI) in a wireless communication system, the method comprising:
grouping total channels into groups according to downlink channel estimates; and
generating feedback information using information of the channel groups.

27. The apparatus of claim 4, wherein the CQI generator for grouping channels in similar statuses among the total frequency channels, starting from a group in the poorest channel status
